(19) United States
(12) Patent Application Publication
(10) Pub. No.: US 2023/0089998 A1
(43) Pub. Date: Mar. 23, 2023

(54) MULTI-CLAUSE DOCUMENT NEGOTIATION PLATFORM

(71) Applicant: Ai-CoNExch, Hoboken, NJ (US)

(72) Inventors: Divyesh Bhakta, Hoboken, NJ (US); Anand Krishnan, Princeton, NJ (US)

(21) Appl. No.: 17/934,152

(22) Filed: Sep. 21, 2022

Related U.S. Application Data
(60) Provisional application No. 63/246,407, filed on Sep. 21, 2021.

(51) Int. Cl. G06Q 50/18; G06Q 10/06

(52) U.S. Cl. CPC G06Q 50/188; G06Q 10/0635

(57) ABSTRACT

A method performed by a computing device has been provided. The method includes (a) receiving a draft digital contract (DDC) from a remote party; (b) dividing the DDC into a plurality of draft clauses; (c) for each draft clause: (1) determining a reference clause of a reference digital contract (RDC) that is most similar to that draft clause; (2) calculating a risk score associated with adopting that draft clause in place of that reference clause; (3) causing to be displayed, on a display device: (i) that draft clause; (ii) that reference clause; and (iii) that calculated risk score; and (4) receiving an instruction from a user whether to accept, reject, or modify that draft clause; (d) in response to detecting that at least one draft clause of the plurality of draft clauses has been accepted by the user, recording acceptance of that draft clause in a blockchain.

### CROSS REFERENCE TO RELATED APPLICATIONS

The present application claims priority to Provisional Patent Application No. 63/246,407 filed Sep. 21, 2021 and entitled “MULTI-CLAUSE DOCUMENT NEGOTIATION PLATFORM,” the disclosure of which is hereby incorporated by reference herein in its entirety for all purposes.

### BACKGROUND

When parties negotiate and execute agreements, one party typically drafts a contract and sends it to the other party for review and negotiation. Each party may engage in a lengthy review of various drafts, having various people examine the entire draft contract every time a new draft is created, until finally the parties agree on the wording and then sign the contract.

The drafting party may initially create the contract by starting with a template contract, such as a contract that was previously negotiated and executed with another party (or the same party in the event of a renegotiation or a renewal), making changes on an ad hoc basis. At each round of the negotiation, each party may redline proposed changes for review by the other party until agreement is converged upon.

### SUMMARY

In one embodiment, a method performed by a computing device is provided. The method includes (a) receiving a draft digital contract (DDC) from a remote party; (b) dividing the DDC into a plurality of draft clauses; (c) for each draft clause: (1) determining a reference clause of a reference digital contract (RDC) that is most similar to that draft clause; (2) calculating a risk score associated with adopting that draft clause in place of that reference clause; (3) causing to be displayed, on a display device: (i) that draft clause; (ii) that reference clause; and (iii) that calculated risk score; and (4) receiving an instruction from a user whether to accept, reject, or modify that draft clause; (d) in response to detecting that at least one draft clause of the plurality of draft clauses has been accepted by the user, recording acceptance of that draft clause in a blockchain. A computer program product implementing the method is also provided. An apparatus and system for use in performing the method are also provided.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects, features, and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention. In the figures:

FIG. 1 illustrates an example system and apparatus for use in connection with one or more embodiments.

FIG. 2 illustrates an example method and computer program product in accordance with one or more embodiments.

FIG. 3 illustrates an example method and computer program product in accordance with one or more embodiments.

FIG. 4 illustrates an example method in accordance with one or more embodiments.

FIG. 5 illustrates an example system, computer program products, and method in accordance with one or more embodiments.

FIG. 6 illustrates an example system and data structures in accordance with one or more embodiments.

FIG. 7 illustrates example data structures in accordance with one or more embodiments.

FIG. 8 illustrates an example system and apparatus for use in connection with one or more embodiments.

FIG. 9 illustrates an example method in accordance with one or more embodiments.

FIGS. 10-25 illustrate example graphical user interfaces for use in connection with one or more embodiments.

### DETAILED DESCRIPTION

### I. Multi-Clause Documents

One or more embodiments include a platform for multi-clause document negotiation. As used herein, a “clause” is a section, sentence, paragraph, or other logical segment of a document relating to a particular statement or concept. A multi-clause document includes multiple distinct clauses. In some examples, clauses are numbered in outline form. Example of multi-clause documents include, but are not limited to: legal contracts; sets of rules or regulations; purchase orders; non-disclosure agreements; product documents; employment offer letters; and product specifications.

### II. System Architecture

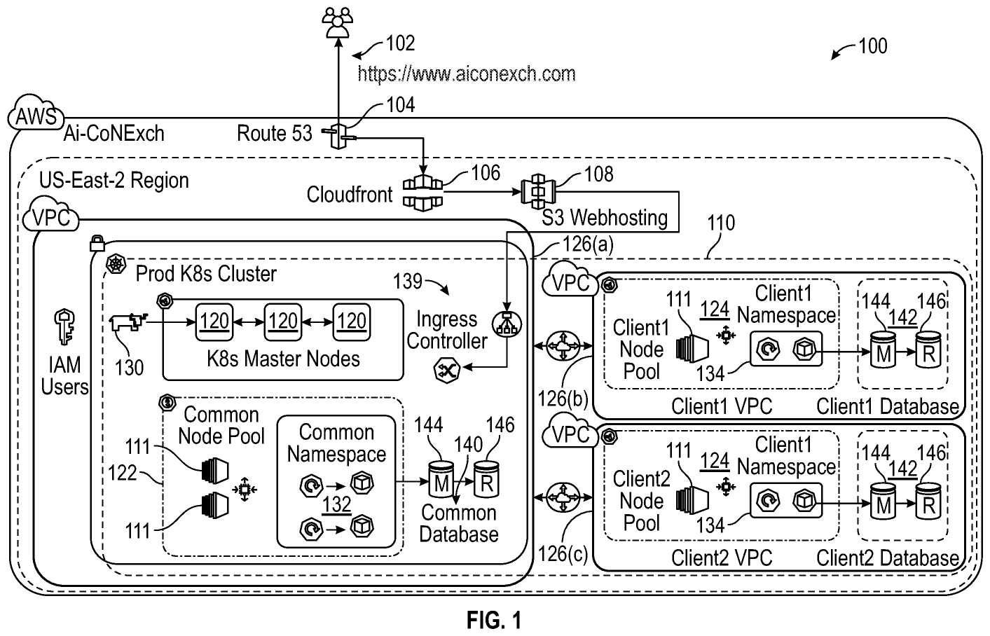

FIG. 1 is a block diagram of an example of a system 100 according to an embodiment. In an embodiment, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Specifically, FIG. 1 is a block diagram of an example of a system 100 including a multi-clause document negotiation platform according to an embodiment. In FIG. 1, various components are illustrated by way of non-limiting examples.

1. The system may include a user interface accessible through a website 102, shown in this example as “https://www.aiconexch.com.” In general, a user interface refers to hardware and/or software configured to facilitate communications between a user and one or more other components of the system. A user interface renders user interface elements and receives input via user interface elements. A user interface may be a graphical user interface (GUI), a command line interface (CLI), a haptic interface, a voice command interface, and/or any other kind of interface or combination thereof. Examples of user interface elements include checkboxes, radio buttons, dropdown lists, list boxes, buttons, toggles, text fields, date and time selectors, command lines, sliders, pages, and forms. Different components of a user interface may be specified in different languages. The behavior of user interface elements may be specified in a dynamic programming language, such as JavaScript. The content of user interface elements may be specified in a markup language, such as hypertext markup language (HTML), Extensible Markup Language (XML), or XML User Interface Language (XUL). The layout of user interface elements may be specified in a style sheet language, such as Cascading Style Sheets (CSS). Alternatively or additionally, aspects of a user interface may be specified in one or more other languages, such as Java, Python, Perl, C, C++, and/or any other language or combination thereof.

2. The system 100 may include a domain name service (DNS) 104, shown in this example as the Amazon “Route 53” DNS.

3. The system 100 may include a content delivery network (CDN) 106, shown in this example as the Amazon “CloudFront” CDN.

4. The system 100 may include a hosting service 108, shown in this example as the Amazon Simple Storage Service (“S3”) hosting service.

5. The system 100 may include multiple nodes 111, 120 implemented as containers or virtual machines, shown in this example as a production Kubernetes (“K8s”) cluster 110. The nodes may include master nodes 120, a common node pool 122, and multiple client node pools 124 in respective virtual private clouds (VPCs) 126(a), 126(b), 126(c). The master nodes 120 and/or other nodes 111 may be managed by a management service 130, shown in this example as the Rancher K8s management service (illustrated as the bull icon). Nodes 111, 120 may be grouped into virtual clusters, show in this example as a common namespace 132 for the common node pool 122 and client namespaces 134 for the respective client node pools 124.

6. The system 100 may include a load balancer, shown in this example as an “ingress controller” 139 for the K8s container environment.

7. The system 100 may include a data repository, show in this example as a “common database” 140 for the common node pool 122 and separate databases 142 for the respective client VPCs 126(b), 126(c). One or more database configurations may include a main database 144 (labeled “M” in FIG. 1) and a replica database 146 (labeled “R” in FIG. 1) used for disaster recovery. In general, a data repository 140, 142 is any type of storage unit and/or device (e.g., a file system, database, collection of tables, or any other storage mechanism) for storing data. A data repository 140, 142 may include multiple different storage units and/or devices. The multiple different storage units and/or devices may or may not be of the same type or located at the same physical site. Further, a data repository 140, 142 may be implemented or may execute on the same computing system as one or more other components of the system. Alternatively or additionally, a data repository may be implemented or executed on a computing system separate from one or more other components of the system 100. A data repository 140, 142 may be logically integrated with one or more other components of the system 100. Alternatively or additionally, a data repository 140, 142 may be communicatively coupled to one or more other components of the system 100 via a direct connection or via a network. In FIG. 1, a data repository is illustrated as storing various kinds of information. Some or all of this information may be implemented and/or distributed across any of the components of the system 100. However, this information is illustrated within the data repository 140, 142 for purposes of clarity and explanation.

In an embodiment, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### III. Natural Language Processing

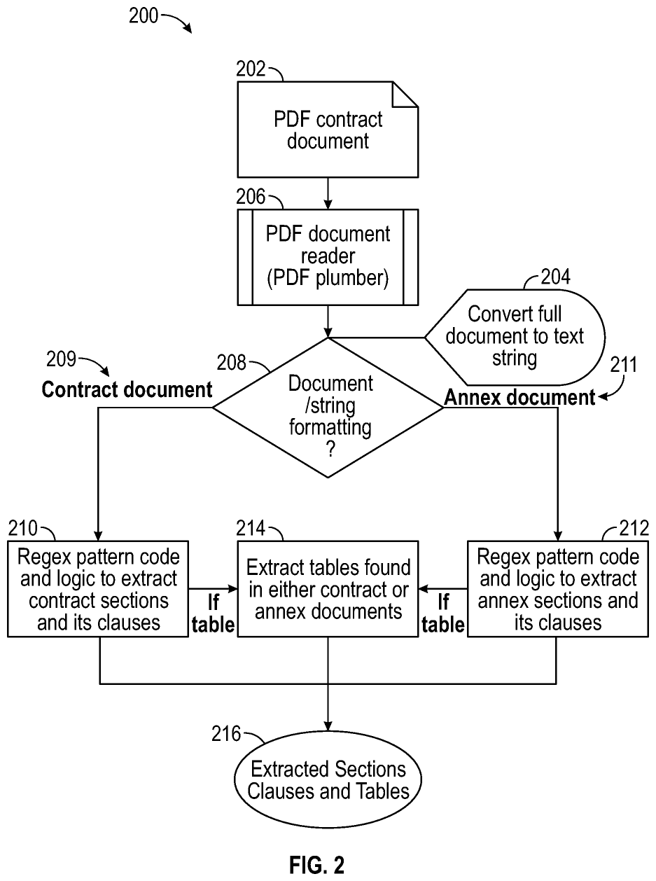

One or more embodiments include natural language processing (NLP) of multi-clause documents. FIG. 2 is a flow diagram 200 of an example of operations for NLP of multi-clause documents according to an embodiment. One or more operations illustrated in FIG. 2 may be modified, rearranged, or omitted all together. Accordingly, the particular sequence of operations illustrated in FIG. 2 should not be construed as limiting the scope of one or more embodiments.

In the example illustrated in FIG. 2, the document 202 is assumed to be a contract in Portable Document Format (PDF) format. Some examples may use a different kind of document format (e.g., a Microsoft® Word, plain text, image, or any other kind of document containing multi-clause text data). FIG. 2 further illustrates converting (step 204) a PDF document 202 to one or more text strings, in this example using the Python package “pdfplumber” 206. In general, one or more embodiments include converting, extracting, and/or normalizing text from a multi-clause document to one or more text strings (or another normalized text format) for further processing. In step 208, document/string formatting is performed to differentiate between contract documents 209 and annex documents 211. In step 210, the identified contract documents 209 are parsed by applying regular expression pattern code and logic to extract contract sections and their clauses. In step 212, the identified annex documents 211 are parsed by applying regular expression pattern code and logic to extract annex sections and their clauses. In step 214, tables are extracted from both contract documents 209 and annex documents 211.

In an embodiment, the operations shown in FIG. 2 generate extracted sections, clauses, and tables (step 216), which the system 100 can operate on as described herein.

### IV. Document Comparison

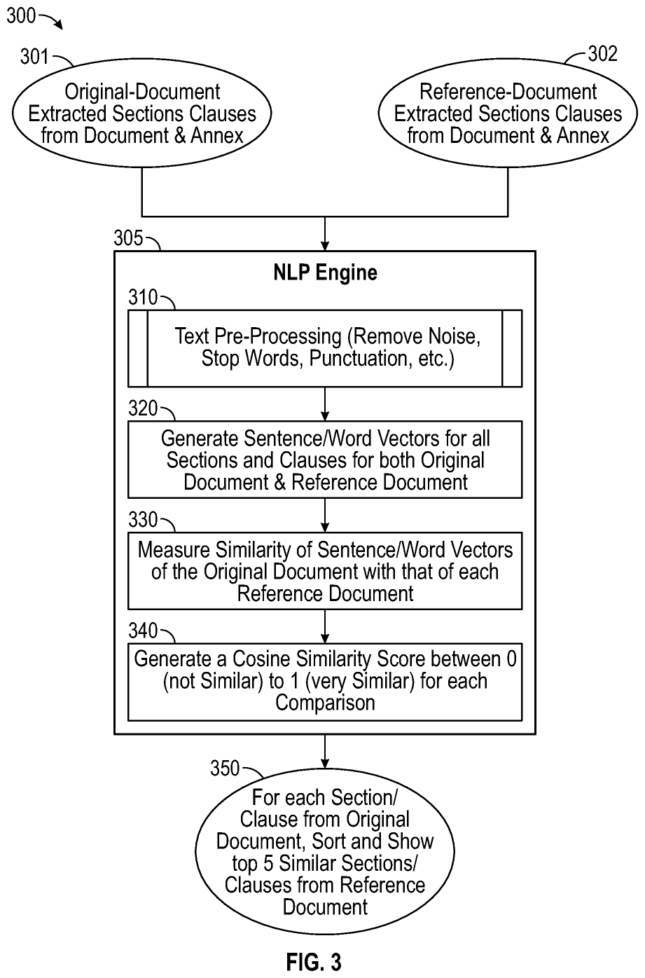

One or more embodiments include comparing multi-clause documents. FIG. 3 is a flow diagram 300 of an example of operations for comparing multi-clause documents according to an embodiment. One or more operations illustrated in FIG. 3 may be modified, rearranged, or omitted all together. Accordingly, the particular sequence of operations illustrated in FIG. 3 should not be construed as limiting the scope of one or more embodiments.

To compare multi-clause documents, a natural language processing (NLP) engine 305 may receive information extracted from the documents, which may include one or more annexes. For example, sections and clauses may be extracted as described above with respect to FIG. 2. In this example, the documents to be compared are referred to as the “original” document 301 and “reference” document 302.

In an embodiment, comparing multi-clause documents 301, 302 includes performing text pre-processing on the documents 301, 302 (e.g., to remove noise, stop words, punctuation, etc.) (step 310), generating sentence/word vectors for all sections and clauses for both the original document 301 and the reference document 302 (step 320), measuring similarity of sentence/word vectors of the original document 301 with that of each reference document 302 (step 330), generating a cosine similarity score between 0 (not similar) and 1 (very similar) for each comparison (step 340), and for each section/clause from the original document 301, sorting and showing the top few (e.g., top 5) sections/clauses from the reference document 302.

Thus, sections and clauses may be sorted by similarity scores, and a certain number of top results (the top five in this example) may be presented in a user interface.

### V. Negotiation Process

One or more embodiments provide a platform for multi-clause document negotiation. Multi-clause document negotiation is described here by way of an example where two users (“User A” and “User B,” also referred to as parties or counterparties) are negotiating the terms of a legal contract. One or more embodiments include software application features specifically tailored to negotiating contract documents. Collectively, those features may be referred to as a “contract module.” Similar features may be applied, with appropriate modifications, to other kinds of multi-clause documents. Alternatively or additionally, the system may be configured to apply the same set of features to two or more kinds of multi-clause documents supported by the system.

This example includes the following operations:

1. User A logs in to the contract module and instructs the system 100 to create a document template with multiple clauses, which may be divided into two or more sections. In this example, the document is a contract agreement.

2. User A instructs the system 100 to generate an agreement using the template and send it to User B. The system 100 may include a listener configured to capture this transaction over a blockchain. An example of a blockchain platform is described in further detail below.

3. For one or more of the clauses, User B instructs the system 100 to perform one of: (a) marking the clause as accepted; (b) marking the clause as rejected; or (c) negotiating the clause using proposed alternative text supplied by User B. The system 100 may be configured to capture each of these actions and send corresponding transactions to the blockchain.

4. User A and/or User B can instruct the system 100 to add a clause to a section, and/or a subclause under an existing clause/subclause. The system 100 may support multiple levels of sections and/or clauses/subclauses.

5. Responsive to determining that all clauses are complete (i.e., accepted or rejected, with no clauses being marked for negotiation), the system 100 may prompt both parties to accept and sign the entire agreement. The signature itself may be considered evidence of acceptance.

6. During the process described above, any user with access to the agreement may instruct the system 100 to present an agreement details interface (e.g., a webpage or portion thereof) and the system 100 may present an activity log associated with the agreement. For example, the system 100 may present the activity log in a right-hand section of a webpage.

7. In an embodiment, the system 100 is configured to obtain the agreement history from blockchain records. For example, the system 100 may fetch the agreement history using a representational state transfer (REST) application programming interface (API). In an embodiment, committing a transaction to the blockchain takes some time (e.g., on the order of 1-2 seconds) and transactions may not be available in the agreement history until they are committed.

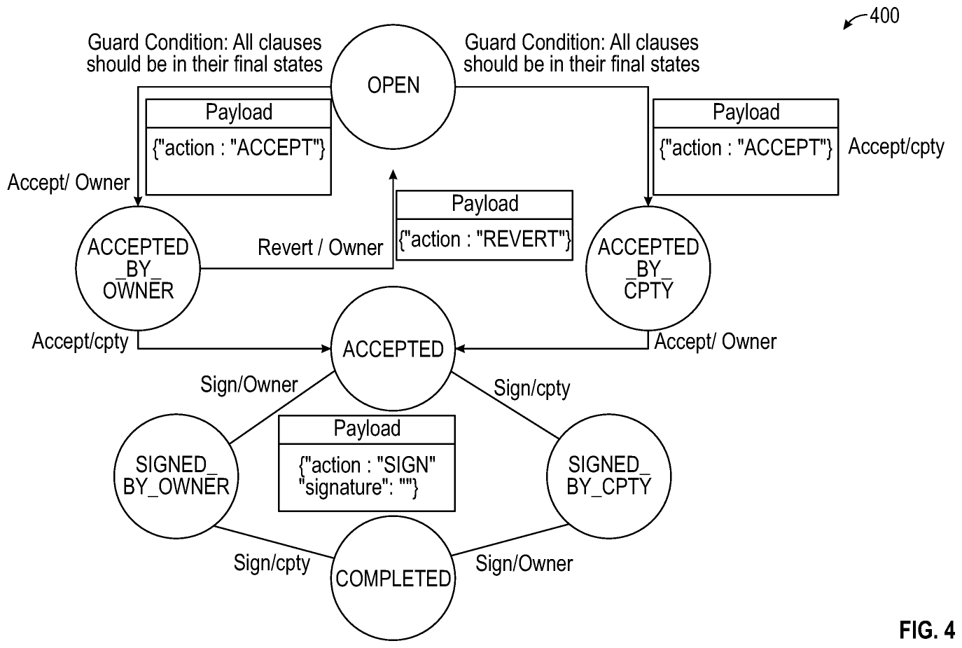

In an embodiment, the process of negotiating a multi-clause document can be represented in a state machine flow diagram. FIG. 4 illustrates an example of a state machine flow diagram 400 according to an embodiment, corresponding to the process described above.

### VI. Blockchain-Based Activity Logs

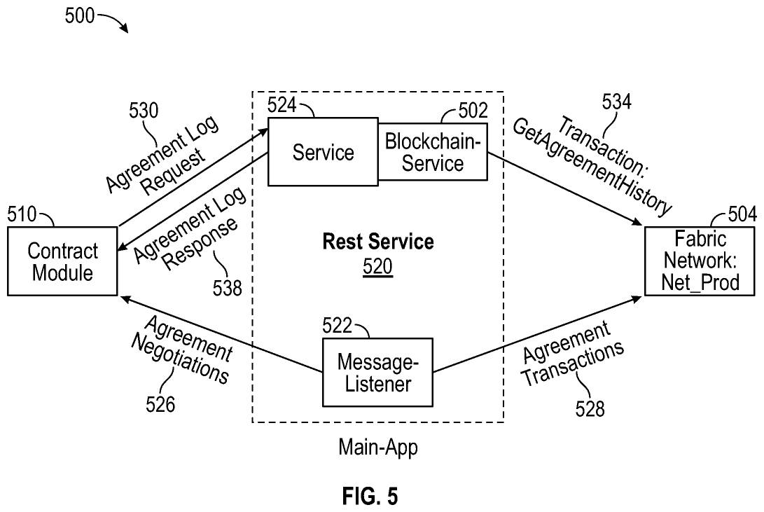

FIG. 5 is a block diagram of an example of a system according to an embodiment. In an embodiment, the system may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

Specifically, FIG. 5 is a block diagram of an example of a system 500 configured to use blockchain-based activity logs according to an embodiment. In the example shown in FIG. 5, a blockchain service 502 is implemented using Hyperledger Fabric, labeled as the “fabric network” 504. Alternatively or additionally, another blockchain service 502 may be used. Software within the system 500 may be implemented in Java, Python, C#, and/or another programming language or combination thereof.

In an embodiment, a single organization (for example, Ai-CoNExch) handles processing of transactions over the blockchain. The organization may provide interfaces for clients (i.e., users) to negotiate multi-clause documents (for example, contracts using a contract module 510 as shown in FIG. 5). The organization may use a certificate authority (CA), in this example Hyperledger Fabric CA, to issue certificates to various users (e.g., admin, peer, or wallet user). The blockchain service 502 may include an ordering service (a.k.a. “orderer”) to order transactions generated by wallets and endorsed by peers. The blockchain service 502 may provide a command line tool (e.g., fabric-ca-client) for enrolling/registering various users with the corresponding CA server. Wallet users may then use the provided certificate/private key.

In the example illustrated in FIG. 5, the system 500 includes a representational state transfer (REST) service 520. The REST service 520 includes a listener, shown as “message-listener” 522, configured to listen to a message broker (e.g., RabbitMQ or another kind of message broker) for contract activities 526 and send corresponding data 528 to the blockchain gateway 504. Alternatively or additionally, the REST service 520 includes a service, shown as “service” 524 configured to respond to a user request 530 for an activity log by fetching 534 the log for an agreement and returning corresponding data 538. In this example, the returned data 538 may be in the form of an array of ActivityLogDTO objects, each including the following data:
uuid: String
title: String
activity: String
time: LocalDateTime
level: String

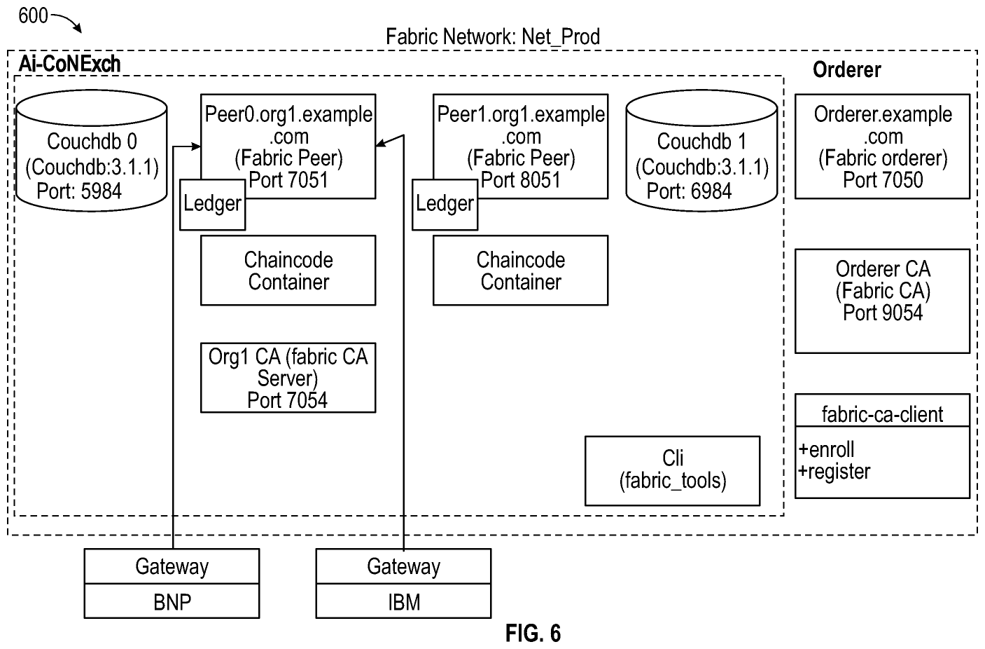

FIG. 6 is a block diagram of an example of a system 600 according to an embodiment. In an embodiment, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

Specifically, the system 600 of FIG. 6 includes an example of components of a blockchain service 502 according to an embodiment. The blockchain service 502 may include components configured to perform various blockchain management operations. In this example, one or more components are implemented in the Java programming language; similar features may be implemented in other programming languages.

Specifically, in the example shown in FIG. 5, two Java based smart contract modules—AgreementContract and AgreementHistory—in an asset-transfer-basic module are compiled and deployed as separate containers in the fabric network peers, and used to execute transactions sent by clients. AgreementContract is used to create and update the agreement state in the blockchain. AgreementHistory is used to store/retrieve logs (or the actions taken) on the agreement.

In an embodiment, AgreementHistory transactions are not called directly by external users. Upon each update to the agreement, AgreementContract initiates creation of a “transaction” of the action taken by one or more negotiating users in the AgreementHistory contract. These transactions pass sufficient additional parameters to maintain the section/clause/subclause hierarchy in the AgreementHistory contract. AgreementHistory uses the hierarchy to return the logs in a tree structure, so that the relationship can be easily used for external reporting.

In an embodiment, additional identity checks may be performed for sensitive transactions. Alternatively or in addition, as noted above, committing a transaction to the blockchain takes some time (e.g., on the order of 1-2 seconds) and transactions may not be available in the agreement state until they are committed.

### VII. Data Storage

In an embodiment, the blockchain service 502 (e.g., Fabric 504 or another blockchain service) includes peer nodes configured to store their state internally (e.g., using a key-value state database such as LevelDB developed by Google). The object store may be configured to store binary data that can be queried using its key. Alternatively or additionally (e.g., for more complex requirements such as obtaining data based on specific fields), a more complex data storage system may be used. For example, Apache CouchDB allows for storing data in JavaScript Object Notation (JSON) format besides binary data, issuing JSON queries against the values, and using indexes to easily query large datasets.

### VIII. Document Hierarchy

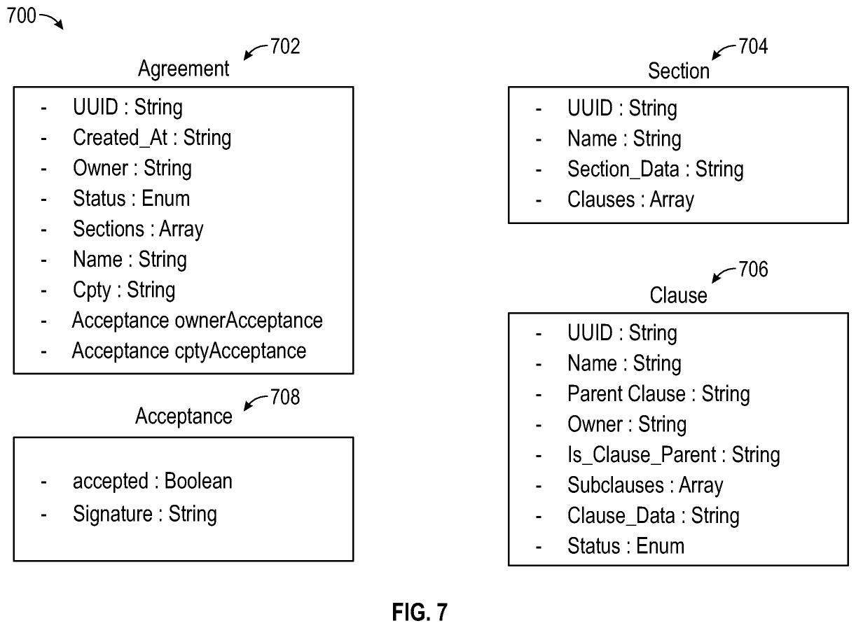

In an embodiment, a multi-clause document includes a hierarchy 700 of sections and clauses, which may be reflected in the data structures used by the system to represent the document. FIG. 7 illustrates examples of data structures according to an embodiment. These examples are provided for illustrative purposes only and should not be construed as limiting one or more embodiments.

In the example illustrated in FIG. 7, an agreement 702 includes sections 704, which in turn include nested clauses 706. For example, see Table 1 below.

TABLE 1

```
Agreement →
  Section 1 →
    Clause 1.1 →
      Clause 1.1.1 →
        Clause 1.1.1.1 →
    Clause 1.2 → . . .
  Section 2 . . .
```

The data structures illustrated in FIG. 7 are configured to support a hierarchy 700 such as that described above. In other embodiments, other hierarchies and/or data structures may be used.

### IX. Environment and Method

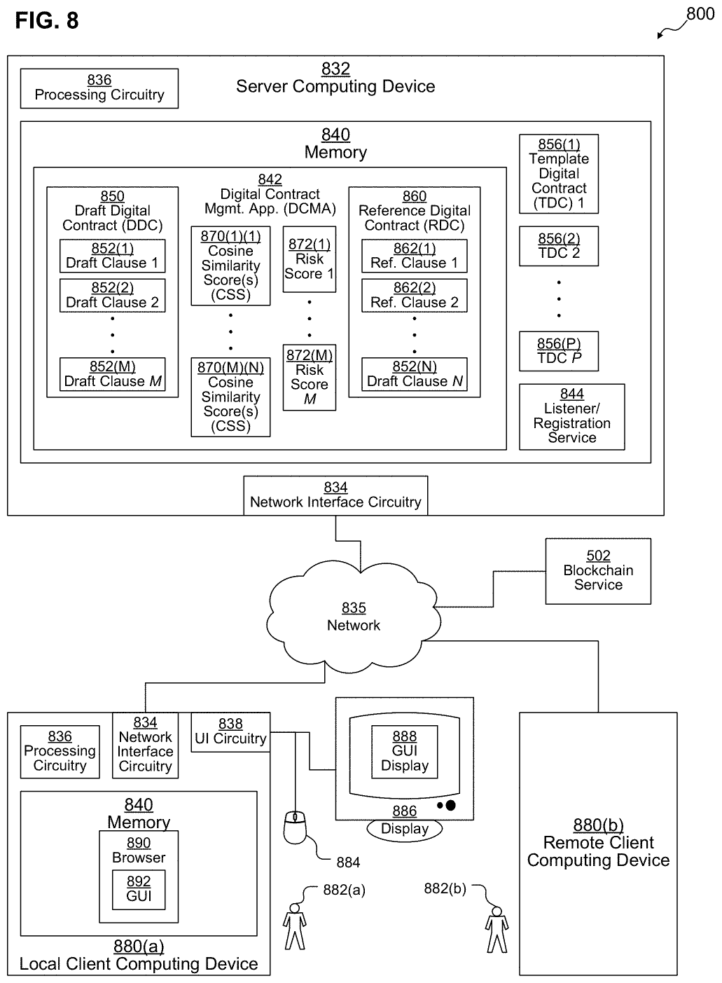

FIG. 8 depicts an example environment 800 for use in connection with various embodiments. Environment 800 includes a server computing device 832 connected to two client computing devices 880(a), 880(b) and a blockchain service 502 via a network 835.

Both client computing devices 880 and server computing device 832 may be any kind of computing device, such as, for example, a personal computer, laptop, workstation, server, enterprise server, tablet, smartphone, etc. Both client computing devices 880 and server computing device 832 include processing circuitry 836, memory 840, and network interface circuitry 834. In addition, client computing devices 880 also include user interface (UI) circuitry 838 for connecting to a UI input device 884 and a display device 886. Client computing devices 880 and server computing device 832 may also include various additional features as is well-known in the art, such as, for example, interconnection buses, etc.

Processing circuitry 836 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 834 may include one or more Ethernet cards, cellular modems, Fibre Channel (FC) adapters, InfiniBand adapters, wireless networking adapters (e.g., Wi-Fi), and/or other devices for connecting to a network 835, such as, for example, a LAN, WAN, SAN, the Internet, a wireless communication network, a virtual network, a fabric of interconnected switches, etc.

Memory 840 may include any kind of digital system memory, such as, for example, random access memory (RAM). Memory 840 stores an operating system (OS, not depicted, e.g., a Linux, UNIX, Windows, MacOS, or similar operating system) and various drivers and other applications and software modules configured to execute on processing circuitry 836.

UI circuitry 838 may include any circuitry needed to communicate with and connect to one or more display screens 886 and user input devices 884 operated by one or more users 882. UI circuitry 884 may include, for example, a keyboard controller, a mouse controller, a touch controller, a serial bus port and controller, a universal serial bus (USB) port and controller, a wireless controller and antenna (e.g., Bluetooth), a graphics adapter and port, etc.

Display screen 886 may be any kind of display, including, for example, a CRT screen, LCD screen, LED screen, etc. Input device 884 may include a keyboard, keypad, mouse, trackpad, trackball, pointing stick, joystick, touchscreen (e.g., embedded within display screen 48), microphone/voice controller, etc. In some embodiments, instead of being external to client computing device 880, the input device 884 and/or display screen 886 may be embedded within the client computing device 880 (e.g., a cell phone or tablet with an embedded touchscreen).

Memory 840 of server computing device 832 stores a digital contract management application (DCMA) 842 and a listener/registration service 844, which are configured to execute on processing circuitry 836 of server computing device 832. Memory 840 of server computing device 832 also stores a set of template digital contracts (TDCs) 856 (depicted as TDCs 856(1), 856(2), . . . , 856(P).

Memory 840 of client computing devices 832 stores a browser 890, which is configured to execute on processing circuitry 836 of client computing devices 880 to interact with DCMA 842 on server computing device 832 and to display a graphical user interface (GUI) 892 on display device 888 and interact with a user 882 via a UI device 884.

In operation, DCMA 842 operates to allow a first user 882(a) of a first (also termed “local” although it may not be local to the server computing device 832) client computing device 880(a) to view a draft digital contract document (DDC) 850 in comparison to a reference digital contract document (RDC) 860 and to interact with the DDC 850. In one example use case, the RDC 860 is drawn from the set of TDCs 856 stored on the server computing device 832. For example, the set of TDCs 856 may be example digital contract documents that the first user 882(a) (or an entity associated with the first user 882(a), such as a first company) has previously executed. In another example use case, the RDC 860 may be a prior draft of the DDC 850 that the first user 882(a) (or an associate) previously proposed to a second user 882(b) (or another entity associated with the second user 882(b), such as a second company) at a second client computing device 880(b). In this latter use case, the DDC 850 is a counterproposal proposed to the first user 882(a) by the second user 882(b).

DMCA 842 operates to parse the DDC 850 into a plurality of M draft clauses 852 (depicted as draft clauses 852(1), 852(2), . . . , 852(M)) (see above in connection with FIGS. 2 and 7). DMCA 842 also operates to parse the RDC 850 into a plurality of N reference clauses 862 (depicted as reference clauses 862(1), 862(2), . . . , 862(N)). DMCA 842 also operates to create cosine similarity scores 870(X)(Y) that depict how similar each draft clause 852(X) is to each reference clause 862(Y) for X=1−M and Y=1−N. DMCA 842 also operates to calculate risk scores 872 to assess how “risky” each draft clause 852(X) would be in comparison to a particular reference clause 862 (e.g., the reference clause 862(Y) having the lowest cosine similarity scores 870(X)(Y) in comparison to draft clause 852(X)). DMCA 842 also operates to cause the risk score 872(X) for each respective draft clause 852(X) to be displayed to the first user 882(a) within GUI display 888 on display 886 together with the text of that draft clause 852(X) and to allow the first user 882(a) to select whether to accept, reject, or modify that draft clause 852(X).

Listener/registration service 844 operates to ascertain when first user 882 accepts a draft clause 852(X). In response, listener/registration service 844 operates to record that acceptance in a blockchain managed by remote blockchain service 502.

Memory 840 may also store various other data structures used by the OS, DMCA 842, listener/registration service 844, browser 890, and various other applications, modules, and drivers. In some embodiments, memory 840 may also include a persistent storage portion. Persistent storage portion of memory 840 may be made up of one or more persistent storage devices, such as, for example, magnetic disks, flash drives, solid-state storage drives, or other types of storage drives. Persistent storage portion of memory 840 is configured to store programs and data even while the computing device 832, 880 is powered off. The OS, DMCA 842, listener/registration service 844, browser 890, and various other applications, modules, and drivers are typically stored in this persistent storage portion of memory 840 so that they may be loaded into a system portion of memory 840 upon a system restart or as needed. The OS, DMCA 842, listener/registration service 844, browser 890, and various other applications, modules, and drivers, when stored in non-transitory form either in the volatile or persistent portion of memory 840, each form a computer program product. The processing circuitry 836 running one or more applications thus forms a specialized circuit constructed and arranged to carry out the various processes described herein.

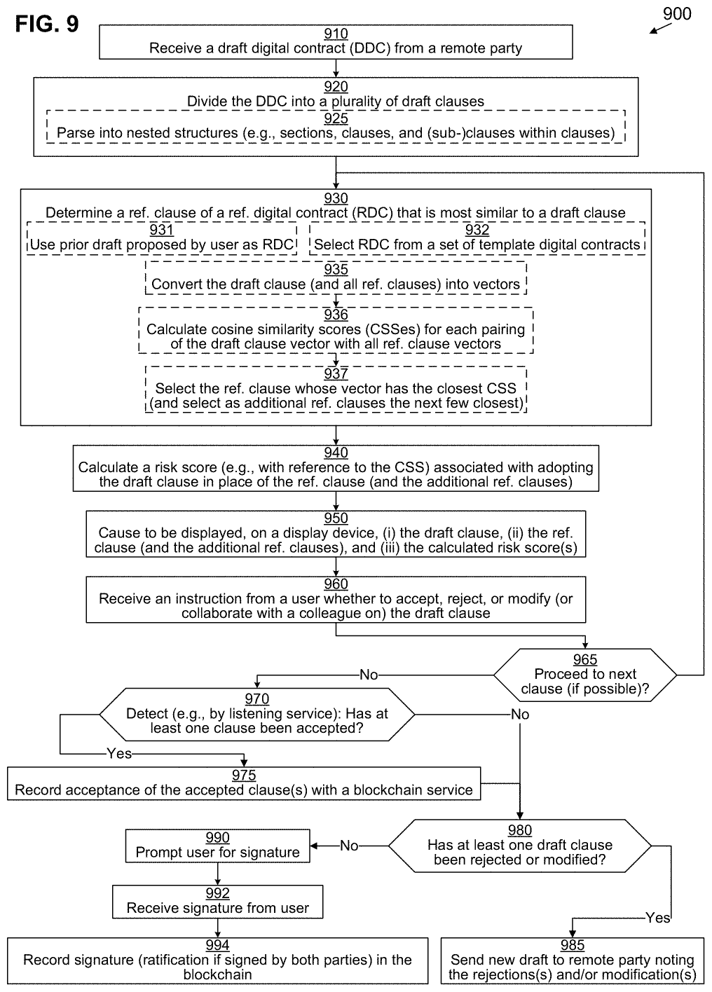

FIG. 9 illustrates an example method 900 performed by server computing device 832 for interacting with a first user 882(a) to improve the process of the first user 882(a) viewing, evaluating, and negotiating draft clauses 852 of a DDC 850 proposed by a remote party (e.g., second user 882(b)). It should be understood that any time a piece of software (e.g., OS, DMCA 842, listener/registration service 844, browser 890, etc.) is described as performing a method, process, step, or function, what is meant is that a computing device (e.g., client computing device 880(a), 880(b) or server computing device 832) on which that piece of software is running performs the method, process, step, or function when executing that piece of software on its processing circuitry 836. It should be understood that one or more of the steps or sub-steps of method 900 may be omitted in some embodiments. Similarly, in some embodiments, one or more steps or sub-steps may be combined together or performed in a different order. Dashed lines indicate that a step or sub-step is either optional or representative of alternate embodiments or use cases.

In step 910, DMCA 842 receives a DDC 850 from a remote party (e.g., second user 882(b) operating remote client computing device 880(b)). Then, in step 920, DMCA divides the DDC 850 in to a plurality of draft clauses 852. In some embodiments, step 920 includes sub-step 925 in which DMCA 842 parses the DDC 850 into nested structures, such as, for example, sections 704, clauses 706, and sub-clauses (which are clauses 706 that are embedded within other clauses). It should be understood that RDC 860 is also parsed into reference clauses 862 in a similar manner, but such parsing may occur in advance, such as at the time that the RDC 860 is first stored on the server computing device 832.

Steps 930, 940, 950, 960 may repeat, iterating over some or all of the M draft clauses 852 within DDC 850. These steps will be discussed in the context of a particular draft clause 852(X).

In step 930, DMCA 842 determines a particular reference clause 862(Y) of RDC 860 that is most similar to the draft clause 852(X). In one use case, step 930 includes sub-step 931 in which DMCA 842 uses a prior draft of the DDC 850 that was previously proposed by the first user 882(a) (or another related party operating the local client computing device 880(a)) to the remote party as the RDC 860. In another use case, step 930 includes sub-step 932 in which DMCA 842 selects the RDC 860 from among a set of TDCs 856 stored on the server computing device 832. In some embodiments, the selection of sub-step 832 may be guided by input from the first user 882(a).

In some embodiments, the selection of the particular reference clause 862(Y) of step 930 may include sub-steps 935, 936, 937. In sub-step 935, DMCA 842 converts the draft clause 852(X) into a vector (see step 320 from FIG. 3 above). All the reference clauses 862 from the RDC 860 should also be converted into vectors as well, but this may have been done in advance. In sub-step 936, DMCA 842 calculates cosine similarity scores 870 for each pairing of the vector generated for the draft clause 852(X) with all vectors generated for respective reference clauses 862 of the RDC 860 (see steps 330, 340 from FIG. 3 above). Then, in sub-step 937, DMCA 842 selects the particular reference clause 862(Y) whose vector has the closest (i.e., largest) cosine similarity score 870 (see step 350 from FIG. 3 above). In some embodiments, sub-step 937 may include selecting several additional reference clauses 862 whose vectors had the next-highest cosine similarity scores.

Then, in step 940, DMCA 842 calculates a risk score 872 (e.g., with reference to the cosine similarity score 870(X)(Y) associated with adopting the draft clause 852(X) in place of the reference clause 862(Y)). The risk score calculation may also take into account the semantic context and semantic meaning of the draft clause 852(X) in comparison to that of the reference clause 862(Y), with synonyms and antonyms playing an important role. For example, if the reference clause 862(Y) reads “Parties will not pursue binding arbitration,” and the draft clause reads “Parties must pursue binding arbitration,” then the risk score will be extremely high because “will not” and “must” are antonyms that completely reverse the meaning. In the event that additional reference clauses 862 were selected in sub-step 937, risk scores 872 are calculated for those additional reference clauses 862 as well.

Then, in step 950, DMCA 842 causes to be displayed, on the display device 888 (e.g., by sending to GUI 892), (i) the draft clause 852(X), (ii) the reference clause 862(Y) (and the additional reference clauses), and (iii) the calculated risk score(s) 872. Step 950 may include presenting selection buttons to the user 882(a) to allow the user 882(a) to input an instruction with respect to the draft clause 852(X).

Then, in step 960, DMCA 842 receives an instruction from the user 882(a) about whether to accept, reject, or modify the draft clause 852(X). In some embodiments, the instruction may also indicate that the user 882(a) wishes to collaborate with a colleague on generating a modification to the draft clause 852(X).

Step 965 signifies that operation returns back to step 930 for the next draft clause 852(X+1) if there is a next draft clause 852(X+1). Otherwise, operation proceeds with step 970.

In step 970, listening/registration service 844 detects whether at least one draft clause 852 has been accepted in step 960. If so, then, in step 975, listening/registration service 844 records that acceptance with the blockchain service 502 (see above in connection with FIGS. 5-6).

Either way, in step 980, after the user 882(a) has made a selection for every draft clause 852, DMCA 842 determines whether at least one draft clause 852 has been rejected or modified by the user 882(a). If so, then, in step 985, DMCA sends a new draft digital contract to the remote client computing device, noting the rejection(s) and modification(s) for the second user 882(b) to evaluate and respond to (e.g., by performance of method 900 with reference to the new draft digital contract).

If all draft clauses 852 in the DDC 850 have been accepted (or if both users 882(a), 882(b) have rejected the same clause 852(X)), then operation proceeds with step 990, in which DMCA 842 prompts the user 882(a) for a signature). When the signature is received (step 992), listening/registration service 844 detects the signature and records the signature with the blockchain service 502. If both parties have signed, then listening/registration service 844 records the ratification of the accepted digital contract with the blockchain service 502.

Later, if a user 882 wishes to view the acceptance and ratification history of a particular contract, the user 882 may query the blockchain service 502 to obtain a list of all acceptance and ratification events.

### X. Graphical User Interface

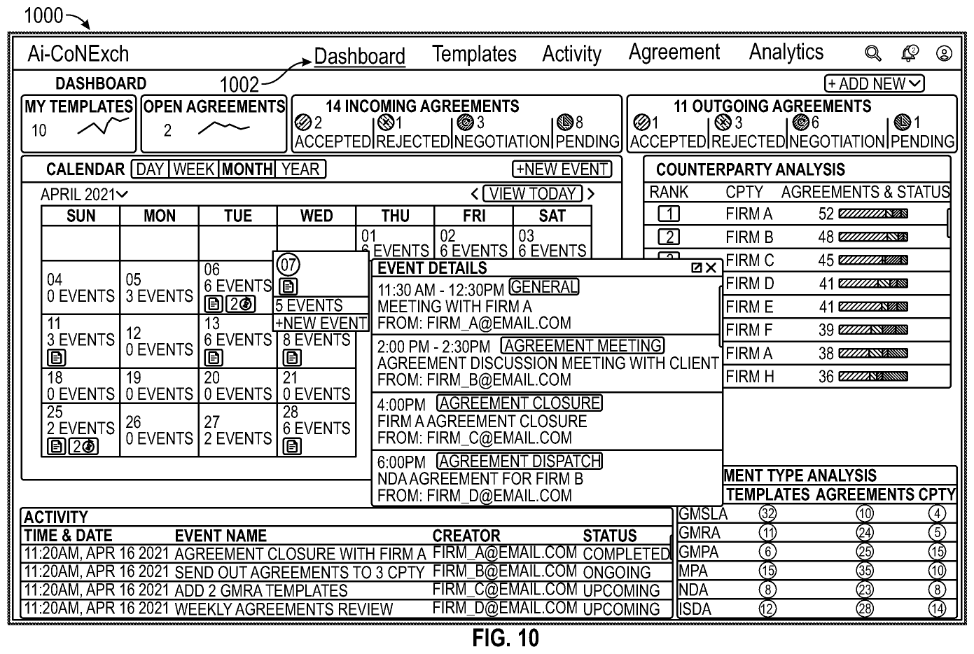

FIGS. 10-25 illustrate an examples of a GUI 892 according to an embodiment. These examples are provided for illustrative purposes only and should not be construed as limiting one or more embodiments.

Specifically, FIGS. 10-25 illustrate examples of a GUI 892 configured to configured to facilitate communications between one or more users 882 and one or more components and processes of a system for multi-clause document negotiation. In addition to components and processes already described above, those include:

1. A “dashboard” interface 1000 (selected with a “Dashboard” tab 1002) that includes succinct summaries of various actions that may be taken by a client/user 882 (e.g., as shown in FIG. 10). For example, the dashboard 1000 may indicate and/or include one or more controls for interacting with one or more of: statuses of agreements; “quick analysis” of agreements; notifications to/from users in the organization, real-time updates and communication; “quick analysis” of counterparties; creating agreements based on templates; etc.

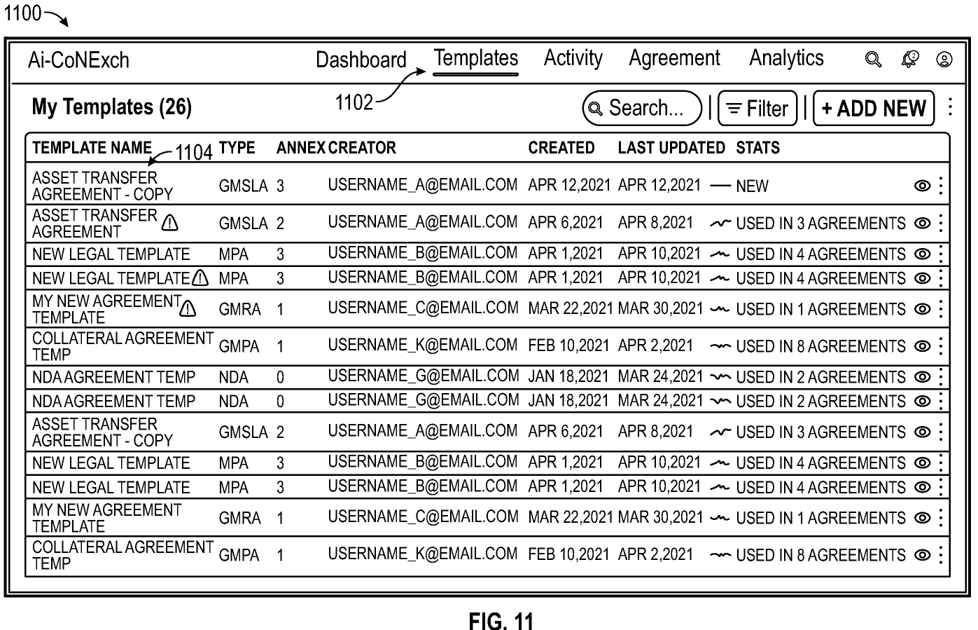

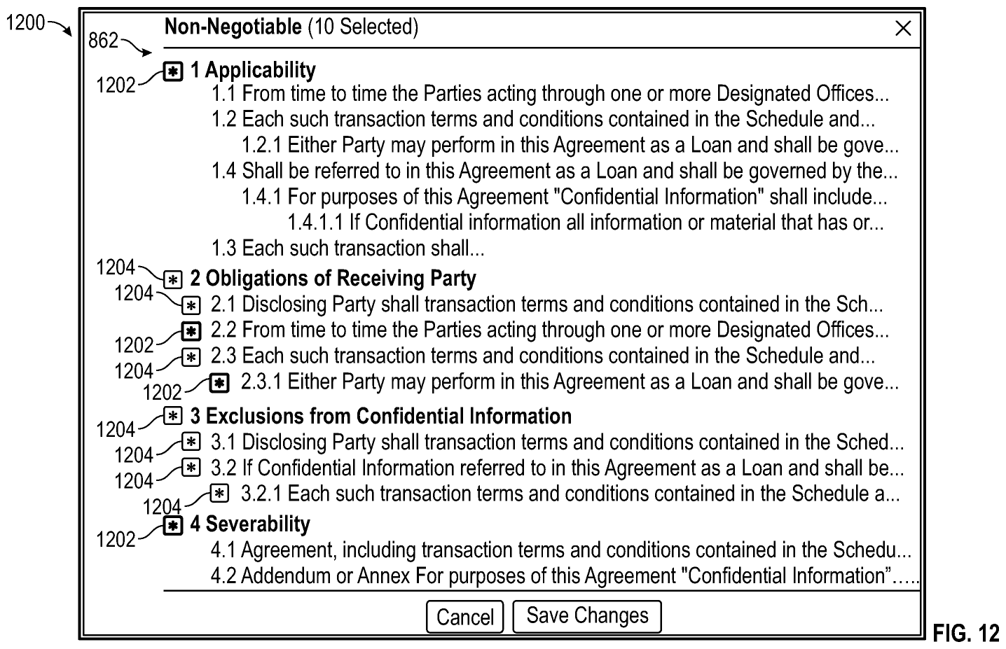

2. A “templates” interface 1100 (selected with a “Dashboard” tab 1102) that includes controls for managing agreement templates 1104 (e.g., as shown in FIGS. 11-12). The controls may allow users to create, edit, search, and/or filter templates pertaining to the organization. Selecting a template 1104 (e.g., by tapping or clicking a control associated with that template 1104) may open the template 1104 to access various template-related features. For example, opening a template 1104 may provide access to controls for reviewing, editing, modifying, and/or saving the template 1104. Template management controls may also allow a user to generate a new agreement from a template 1104. FIG. 12 depicts an example control window 1200 that allows a user 882 to mark particular reference clauses 862 (and sub-clauses) as being considered non-negotiable (marked with a non-negotiable marker 1202) or negotiable (marked with a negotiable marker 1204).

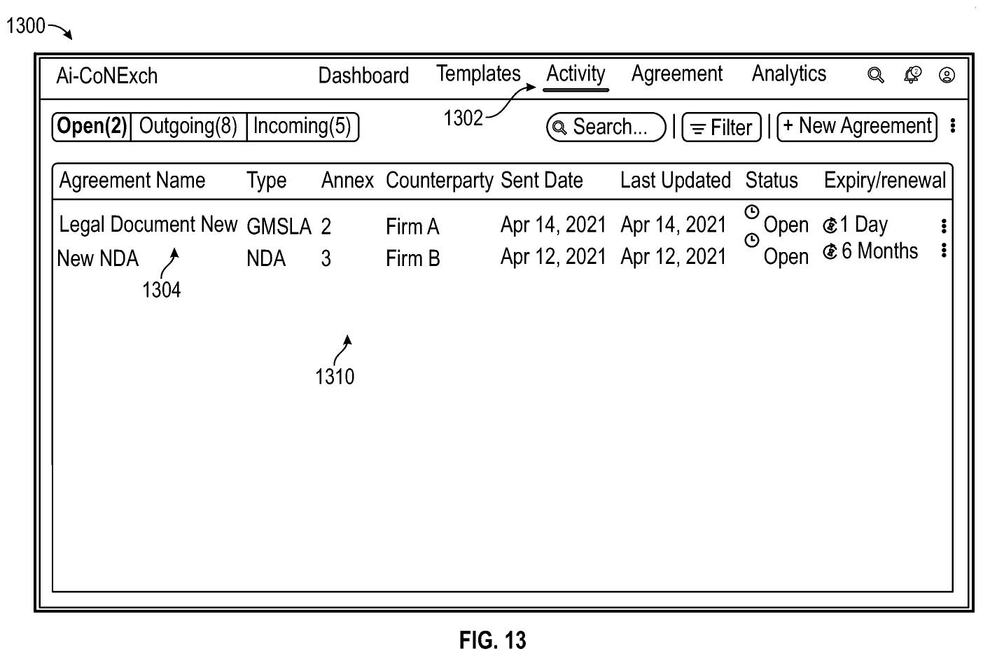

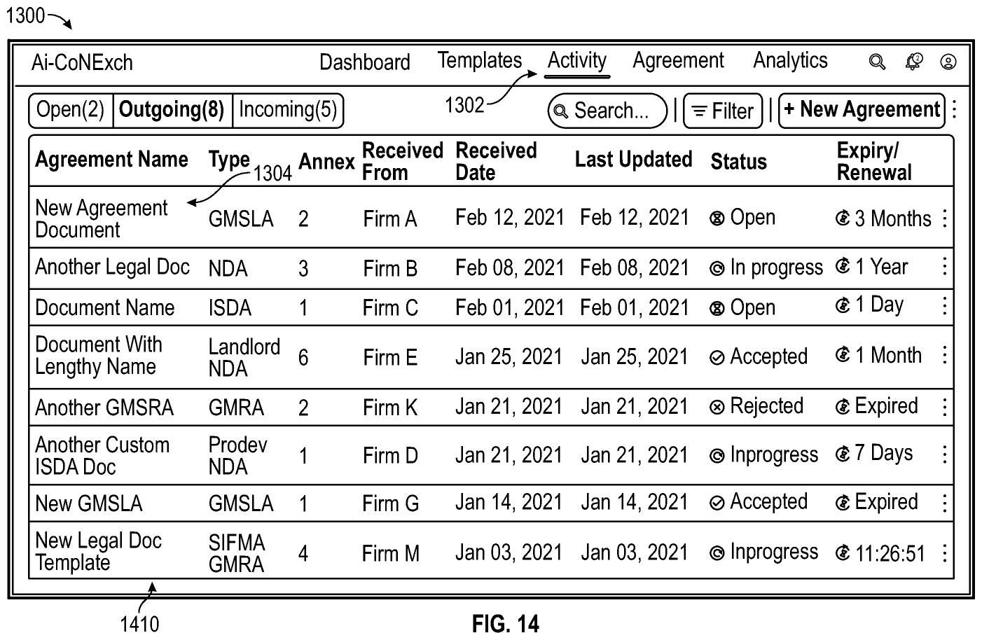

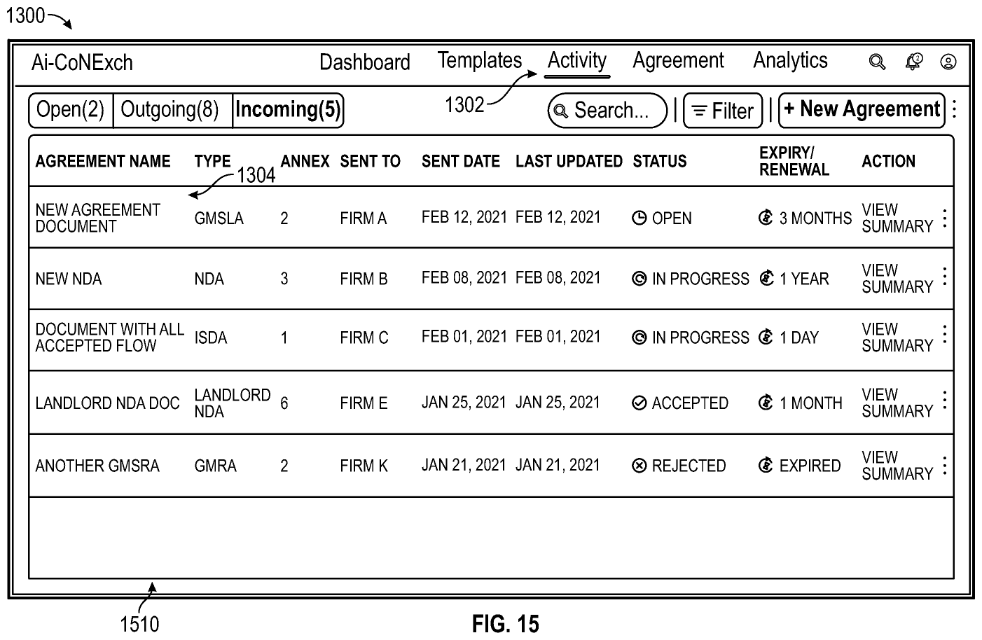

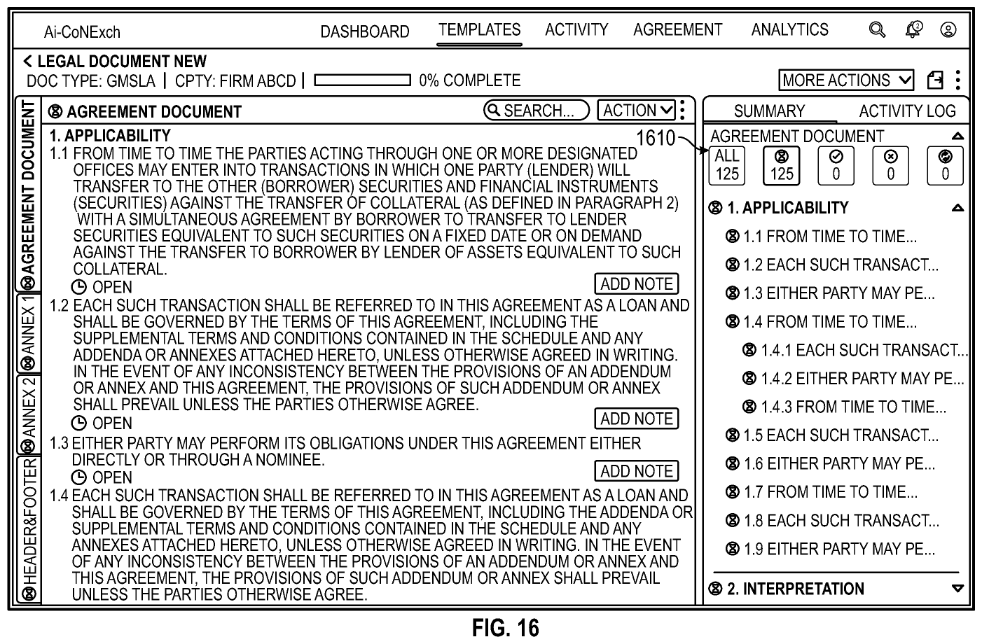

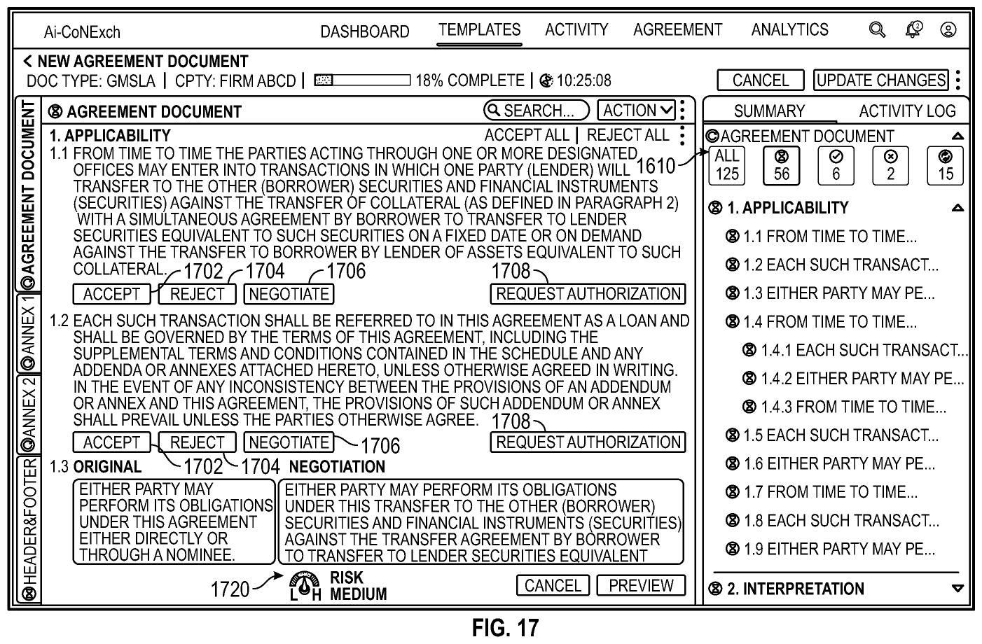

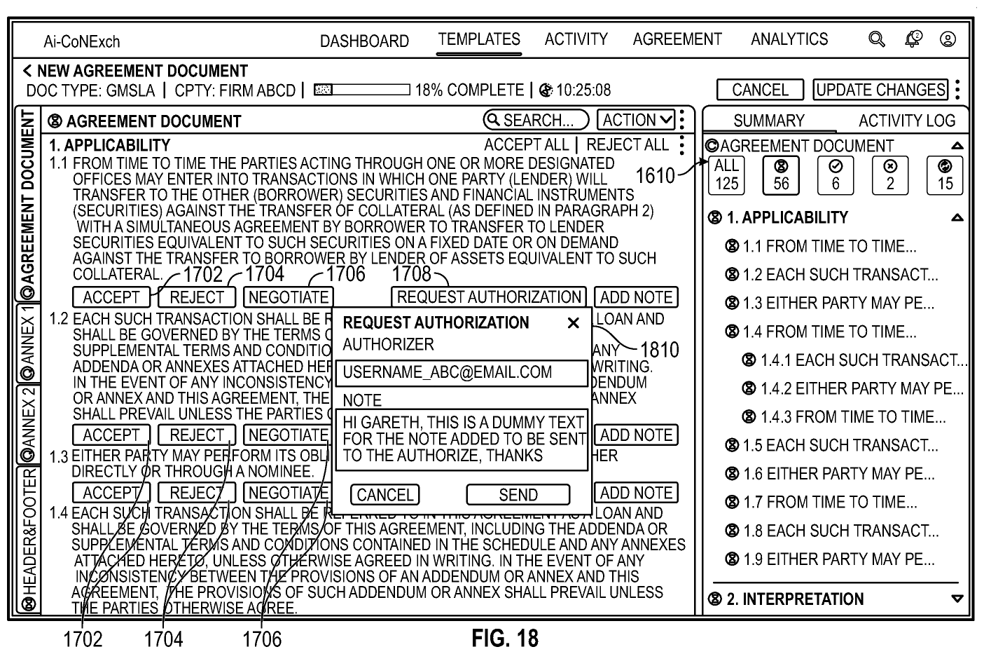

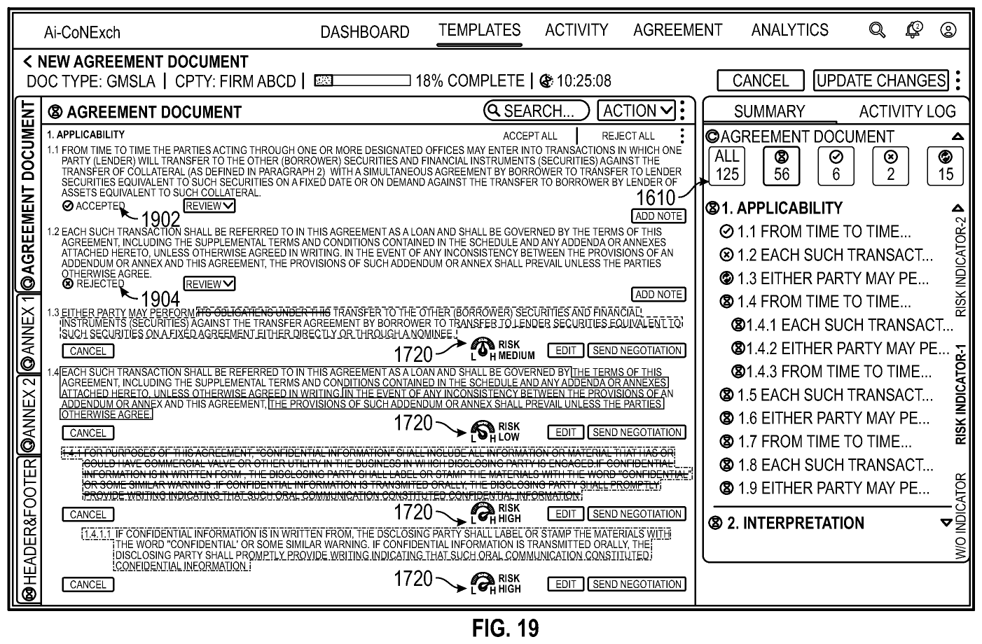

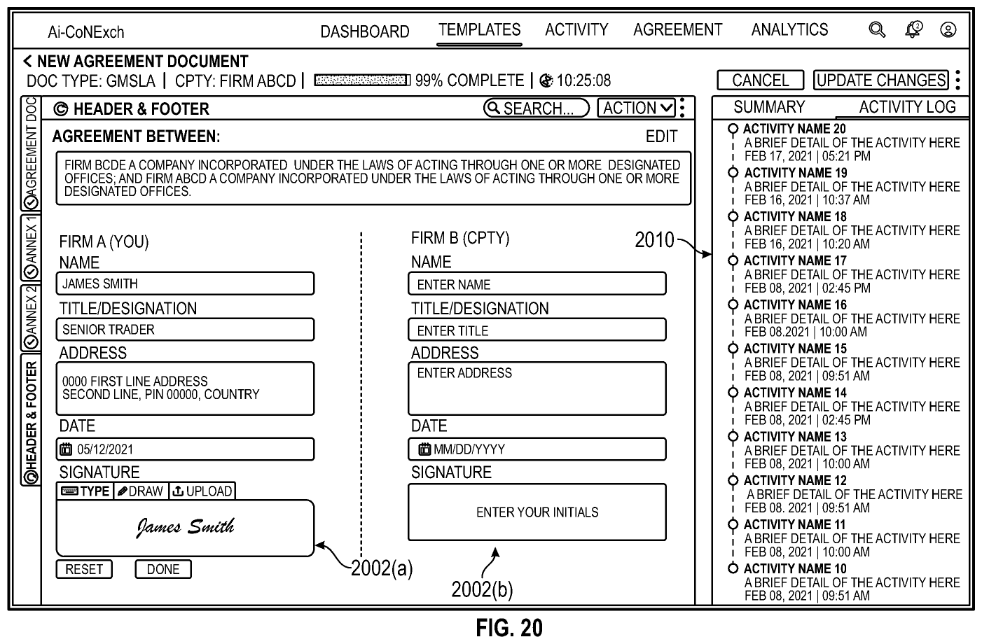

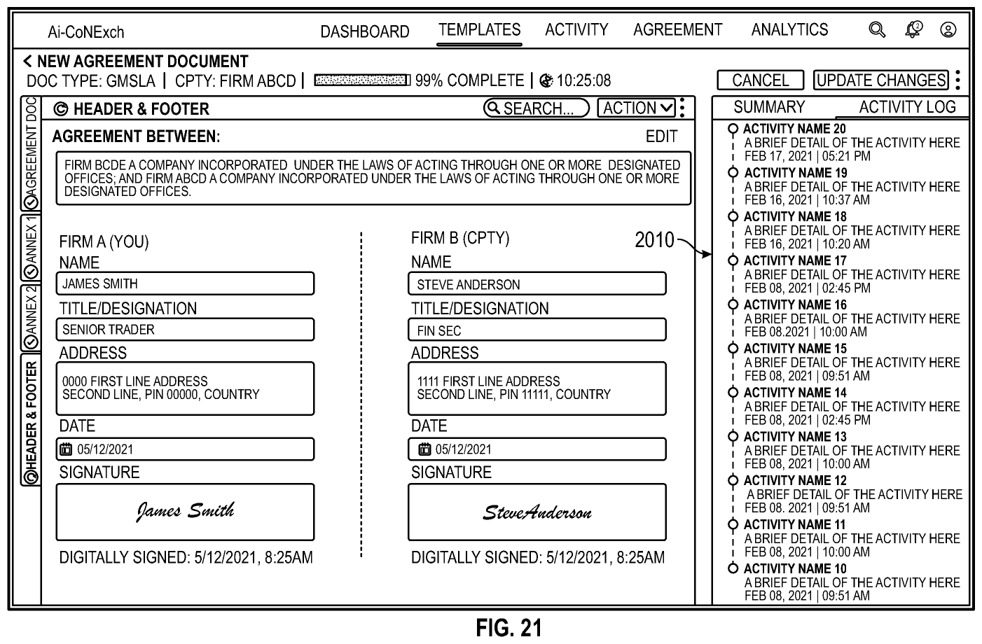

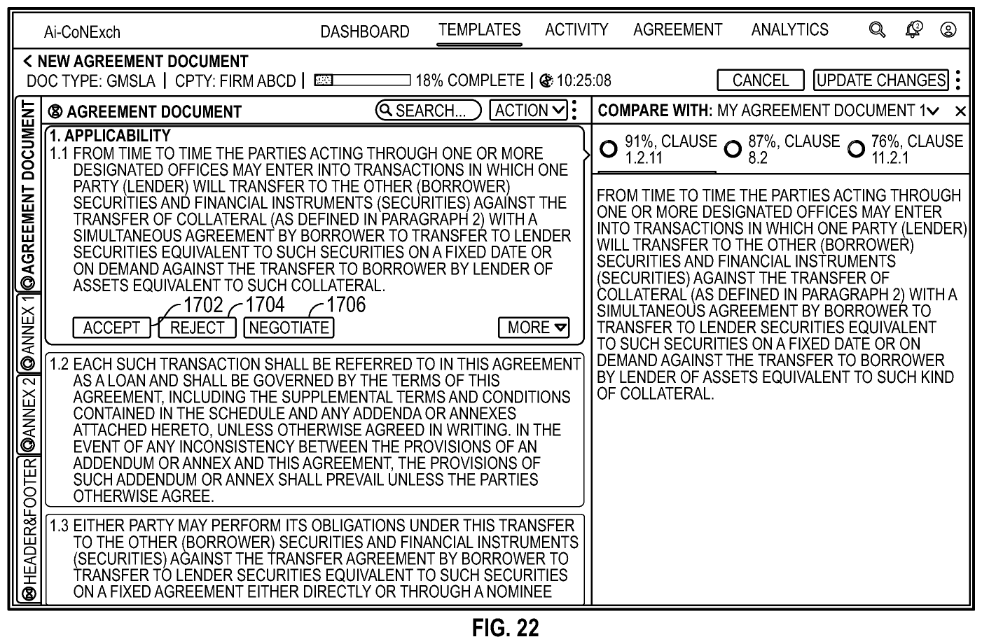

3. An “activity” interface 1300 (selected with an “Activity” tab 1302) that includes controls for viewing and/or interacting with recent workflow activity (e.g., as shown in FIGS. 13-22). Workflow activity may be divided into queues such as an open queue 1310 (FIG. 13), an incoming queue 1510 (FIG. 15), an outgoing queue 1410 (FIG. 14), etc. When a user 882(a) creates an agreement 1304 from a template 1104, the agreement 1304 may move into the “open” queue 1310. The “open” queue 1310 may include controls to select, edit, modify, save, etc. the agreement. When the agreement is ready, the user 882(a) may be able to send the agreement 1304 to an “online” or “offline” counterparty. In this context, an “online” counterparty is one who is a user 882(b) of the same negotiation platform; an “offline” counterparty is one who is not a user of the same negotiation platform and receives a on-time invitation to participate in the agreement negotiation workflow via the platform. An agreement 1304 sent to a counterparty may be moved to the “outgoing” queue 1410. An agreement 1304 received from a counterparty may be shown in the “incoming” queue 1510. Some workflow-related activities 2010, such as accepting, rejecting, and/or negotiating terms, may be performed at the agreement level. The interface may include statistics 1610 relating to the statuses of agreements and/or parts thereof. For example, with reference to FIG. 16, the statistics 1610 indicate that out of 125 total sections 704 and clauses 706 (and sub-clauses), 125 have yet to be acted upon, zero have been accepted, zero have been rejected, and zero have been modified, while the statistics 1610 in FIGS. 17-19 indicate that out of 125 total sections 704 and clauses 706 (and sub-clauses), 56 have yet to be acted upon, 6 have been accepted, 2 have been rejected, and 15 have been modified. FIG. 16 depicts several clauses 1.1, 1.2, 1.3 that have yet to be acted upon (i.e., they are “Open”). FIG. 17 depicts several clauses 1.1, 1.2 that have yet to be acted upon, each having an “Accept” control element 1702 (used to accept a draft clause 852), a “Reject” control element 1704 (used to reject a draft clause 852), a “Negotiate” Control element 1706 (used to modify a draft clause 852), and a “Request Authorization” Control element 1708 (used to request assistance from a colleague on a draft clause 852). User 882(a) may select these control elements 1702-1708 via GUI 892. FIG. 17 also depicts clause 1.3 currently in the midst of being modified, with the original text of the draft clause 852 on the left, and what the user 882(a) has typed in as the modified version on the right. FIG. 17 also depicts a risk indicator 1720 that graphically depicts a risk score 872 associated with the modification. FIG. 18 adds a “Request Authorization” control window 1810 that allows the user 882(a) to provide details for requesting assistance from a colleague. FIG. 19 depicts clause 1.1 as having been accepted, as indicated by acceptance indicator 1902; clause 1.2 as having been rejected, as indicated by rejection indicator 1904; and clauses 1.3 and 1.4 and sub-clauses 1.4.1 and 1.4.1.1 as being open. Because clauses 1.3 and 1.4 and sub-clauses 1.4.1 and 1.4.1.1 have all been modified by the remote user 882(b) with reference to the RDC 862, clauses 1.3 and 1.4 and sub-clauses 1.4.1 and 1.4.1.1 each include a risk indicator 1720. As depicted, because clause 1.4 is shown as having low risk, the changes are highlighted in green; because clause 1.3 is shown as having medium risk, the changes are highlighted in yellow, and because sub-clauses 1.4.1 and 1.4.1.1 are shown as having high risk, the changes are highlighted in pink/red. FIGS. 20 and 21 depict signature fields 2002(a) (for user 882(a)) and 2002(b) (for user 882(b)) to use to formally accept the agreement 1304. In FIG. 20, only user 882(a) has signed, while in FIG. 21, both users 882(a), 882(b) have signed, ratifying the agreement 1304. FIG. 22 depicts an option to choose between comparing a draft clause 1.1 to three different reference clauses 862 having different similarity scores 870 (e.g., 91%, 87%, and 76%).

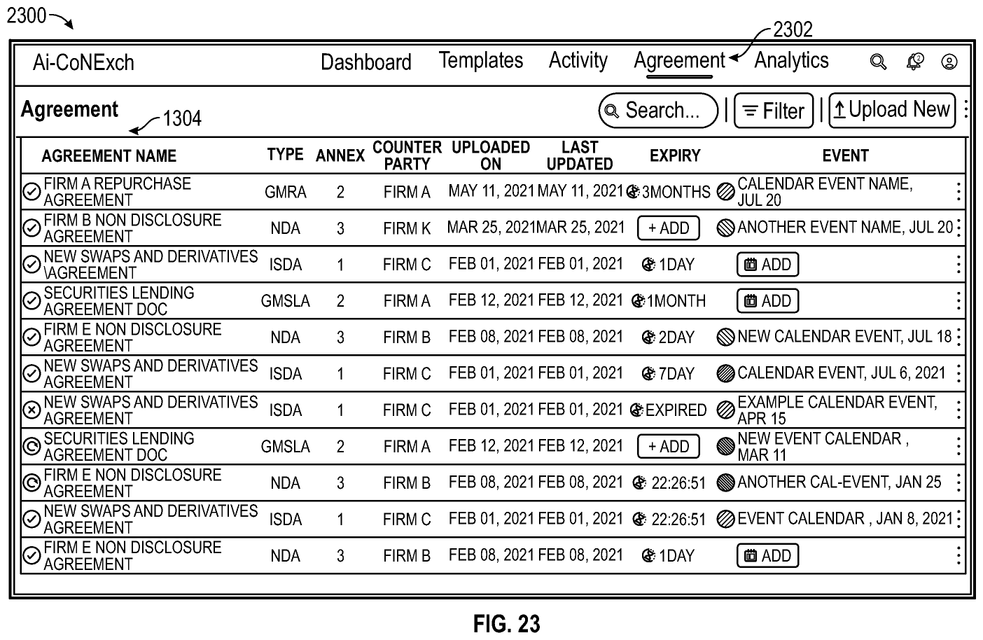

4. An “agreement” interface 2300 (selected with an “Agreement” tab 2302) that includes controls for managing aspects of agreements, including closed and/or ongoing (i.e., in the negotiation process) agreements (e.g., as shown in FIG. 23). The controls may allow users 882 to track events/tasks, assign events/tasks to a calendar, invite others to events/tasks, etc. The controls may allow users 882 to add expiry and/or other parameters to agreements 1304. The controls may include search and/or filter features for more readily accessing specific agreements. The controls may allow a user 882 to upload a new agreement 1304 to the platform as a portable document format (PDF) file, Microsoft Word file, and/or other file format supported by the platform. The platform may normalize uploaded agreements 1304. The controls may allow a user 882 to compare an incoming agreement 1304 (e.g., DDC 850) to one or more other agreement(s) 1304 and/or version(s) thereof (e.g., RDC 860), to see differences for negotiation and/or other workflow purposes.

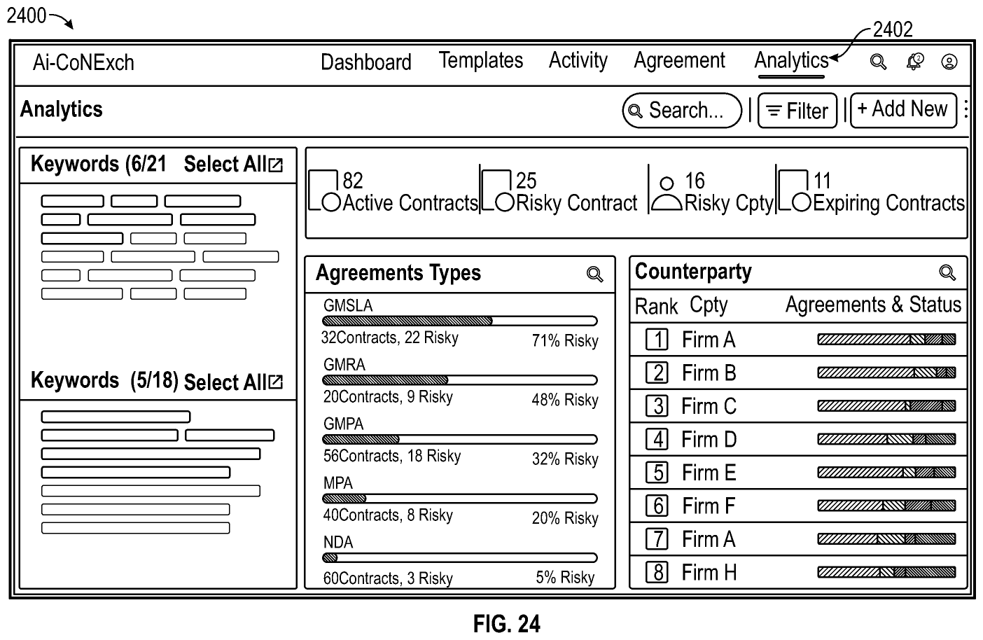

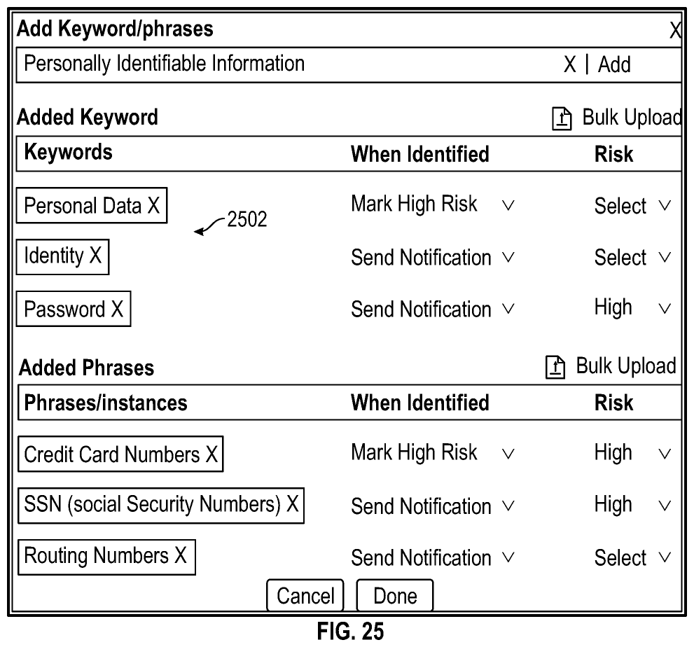

5. An “analytics” interface 2300 (selected with an “Analytics” tab 2402) that includes controls for viewing analytics generated, for example, using data science algorithms (e.g., as shown in FIGS. 24-25). The analytics may include one or more of: “key word” risk analysis; “key phrase” risk analysis; “key events” risk analysis; etc. The controls may allow users 882 to search multiple agreements for keywords 2502, search and replace terms in one or more agreements 1304; send agreements 1304 to counterparties for negotiation; etc. The controls may allow a user 882 to configure risk analytics with risk parameters that are propagated through the various platform interfaces.

### XI. Conclusion

While various embodiments of the invention have been particularly shown and described, it will be understood by those skilled in the art that various changes in form and details may be made therein without departing from the spirit and scope of the invention as defined by the appended claims. It should be understood that the term “set” as used throughout this document refers to a mathematical set having at least one element.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicant makes no admission that such technique, method, apparatus, or other concept is actually prior art under 35 U.S.C. § 102 or 103, such determination being a legal determination that depends upon many factors, not all of which are known to Applicant at this time.

What is claimed is:

1. A method performed by a computing device, the method comprising:
receiving a draft digital contract (DDC) from a remote party;
dividing the DDC into a plurality of draft clauses;
for each draft clause:
determining a reference clause of a reference digital contract (RDC) that is most similar to that draft clause;
calculating a risk score associated with adopting that draft clause in place of that reference clause;
causing to be displayed, on a display device:
that draft clause;
that reference clause; and
that calculated risk score; and
receiving an instruction from a user whether to accept, reject, or modify that draft clause;
in response to detecting that at least one draft clause of the plurality of draft clauses has been accepted by the user, recording acceptance of that draft clause in a blockchain.

2. The method of claim 1 wherein the method further comprises, in response to at least one other draft clause of the plurality of draft clauses being rejected or modified by the user, notifying the remote party that the user has rejected or modified the at least one other draft clause.

3. The method of claim 1 wherein dividing the DDC into a plurality of draft clauses includes parsing the DDS into a plurality of nested data structures representing sections and clauses.

4. The method of claim 1 wherein determining the reference clause of the reference digital contract (RDC) that is most similar to that draft clause includes:
converting that draft clause into a vector;
calculating a cosine similarity for each pairing of the vector created for that draft clause with a respective vector of each reference clause of a plurality of reference clauses of the RDC; and
selecting as the reference clause, the reference clause of the plurality of reference clauses of the RDC whose vector has a lowest calculated cosine similarity with respect to that draft clause.

5. The method of claim 4 wherein calculating the risk score associated with adopting that draft clause in place of that reference clause is based on a combination of the cosine similarity calculated between that draft clause and that reference clause as well as on a semantic meaning or semantic context of that draft clause within the DDC in comparison to a semantic meaning or semantic context of that reference clause within the RDC.

6. The method of claim 4 wherein the method further comprises, for each draft clause:
selecting as additional reference clauses for that draft clause, a predetermined number of other reference clauses of the plurality of reference clauses of the RDC whose respective vectors have next lowest calculated cosine similarities with respect to that draft clause;
calculating additional risk scores respectively associated with adopting that draft clause in place of the additional reference clauses; and
causing to be displayed, on the display device, the calculated additional risk scores.

7. The method of claim 1 wherein the method further comprises selecting the RDC from a plurality of template digital contracts stored on the computing device.

8. The method of claim 1 wherein the method further comprises selecting a prior draft of the DDC as the RDC.

9. The method of claim 1 wherein:
the user and the remote party are both remote from the computing device and from each other;
the user is connected to a remote computing device that maintains a network connection to the computing device; and
causing the draft clause, reference clause, and risk score to be displayed on the display device includes sending the draft clause, reference clause, and risk score to the remote computing device for display within a graphical user interface of the remote computing device.

10. The method of claim 1 wherein the method further comprises:
in response to all clauses being accepted by the user, prompting the user to sign the DDC; and
in response to detecting that the user has signed the DDC, recording complete acceptance of the DDC by the user in the blockchain.

11. The method of claim 10 wherein the method further comprises:
in response to the user signing the DDC, prompting the remote party to sign the DDC; and
in response to detecting that the remote party has signed the DDC, recording ratification of the DDC in the blockchain.

12. The method of claim 1 wherein detecting that at least one draft clause of the plurality of draft clauses has been accepted by the user is performed by a listening service executing on the computing device, the listening service being configured to communicate with the blockchain service.

13. The method of claim 1 wherein the method further comprises:
an entity requesting an acceptance history of the DDC;
in response to the entity requesting the acceptance history, querying the blockchain service for acceptances of draft clauses of the DDC;
receiving cryptographically authenticated timestamped acceptance records of draft clauses of the DDC from the blockchain service; and
causing details of the received cryptographically authenticated timestamped acceptance records of draft clauses of the DDC to be displayed to the entity.

14. A system comprising:
a first client computing device;
a second client computing device;
a computer network; and
a server computing device communicatively coupled to the first client computing device and the second client computing device via the computer network, the server computing device being configured to:
receive a draft digital contract (DDC) from a remote party at the second client computing device;
divide the DDC into a plurality of draft clauses;
for each draft clause:
determine a reference clause of a reference digital contract (RDC) that is most similar to that draft clause;
calculate a risk score associated with adopting that draft clause in place of that reference clause;
cause to be displayed, on a display device of the first client computing device:
that draft clause;
that reference clause; and
that calculated risk score; and
receive an instruction from a user at the first client computing device whether to accept, reject, or modify that draft clause;
in response to detecting that at least one draft clause of the plurality of draft clauses has been accepted by the user, record acceptance of that draft clause in a blockchain.

15. The system of claim 14 wherein the server computing device is further configured to, in response to at least one other draft clause of the plurality of draft clauses being rejected or modified by the user, notify the remote party at the second client computing device that the user has rejected or modified the at least one other draft clause.

16. The system of claim 15 wherein:
the server computing device is further configured to, in response to the at least one other draft clause being rejected or modified by the user:
determine a new reference clause of the DDC that is most similar to the at least one other draft clause; and
calculate a new risk score associated with adopting the at least one other draft clause in place of the new reference clause;
notifying the remote party at the second client computing device that the user has rejected or modified the at least one other draft clause includes causing to be displayed, on another display device of the second client computing device:
the at least one other draft clause;
the new reference clause; and
the new risk score; and
the server computing device is further configured to, in response to detecting that the at least one other draft clause of the plurality of draft clauses has been accepted by the remote party, recording acceptance of the at least one other draft clause in the blockchain.

17. The system of claim 16 wherein the server computing device is further configured to:
in response to detecting that the at least one other draft clause of the plurality of draft clauses has been accepted by the remote party, prompt the remote party to sign the DDC as modified by the at least one other draft clause; and
in response to detecting that the remote party has signed the DDC as modified by the at least one other draft clause, record complete acceptance of the DDC, as modified by the at least one other draft clause, by the remote party in the blockchain.

18. The system of claim 17 wherein the server computing device is further configured to:
in response to the remote party signing the DDC as modified by the at least one other draft clause, prompting the user to sign the DDC as modified by the at least one other draft clause; and
in response to detecting that the user has signed the DDC, as modified by the at least one other draft clause, recording ratification of the DDC, as modified by the at least one other draft clause, in the blockchain.

19. A computer program product comprising a non-transitory computer-readable storage medium storing instructions, which, when executed by a computing device, causes the computing device to:
receive a draft digital contract (DDC) from a remote party;
divide the DDC into a plurality of draft clauses;
for each draft clause:
determine a reference clause of a reference digital contract (RDC) that is most similar to that draft clause;
calculate a risk score associated with adopting that draft clause in place of that reference clause;
cause to be displayed, on a display device:
that draft clause;
that reference clause; and
that calculated risk score; and
receive an instruction from a user whether to accept, reject, or modify that draft clause;
in response to detecting that at least one draft clause of the plurality of draft clauses has been accepted by the user, record acceptance of that draft clause in a blockchain.

20. The computer program product of claim 19 wherein determining the reference clause of the reference digital contract (RDC) that is most similar to that draft clause includes:
converting that draft clause into a vector;
calculating a cosine similarity for each pairing of the vector created for that draft clause with a respective vector of each reference clause of a plurality of reference clauses of the RDC; and
selecting as the reference clause, the reference clause of the plurality of reference clauses of the RDC whose vector has a lowest calculated cosine similarity with respect to that draft clause.
